(19) United States
(12) Patent Application Publication
(10) Pub. No.: US 2022/0171199 A1
(43) Pub. Date: Jun. 2, 2022

(54) HEAD-MOUNTED DISPLAY

(71) Applicant: JVCKENWOOD Corporation, Yokohama-shi (JP)

(72) Inventor: Hisashi Oka, Yokohama-shi (JP)

(21) Appl. No.: 17/675,714

(22) Filed: Feb. 18, 2022

Related U.S. Application Data
(63) Continuation of application No. PCT/JP2020/015630, filed on Apr. 7, 2020.

(30) Foreign Application Priority Data
Aug. 28, 2019 (JP) 2019-155670

(51) Int. Cl. G02B 27/01; G02B 27/10; G02B 5/30

(52) U.S. Cl. CPC G02B 27/0172; G02B 27/10; G02B 27/0101; G02B 2027/0134; G02B 2027/0123; G02B 2027/013; G02B 5/30

(57) ABSTRACT

A head-mounted display according to an embodiment includes a left-eye optical system configured to guide display light for forming a left-eye display image to a left eye of a user, a right-eye optical system configured to guide display light for forming a right-eye display image to a right eye of the user, and a polarizing plate arranged between a left front space and a right front space, and the left front space is a space defined by the left-eye optical system, and the right front space is a space defined by the right-eye optical system.

### CROSS REFERENCE TO RELATED APPLICATION

This application is based upon and claims the benefit of priority from Japanese patent application No. 2019-155670 filed on Aug. 28, 2019, the disclosure of which is incorporated herein in its entirety by reference.

### BACKGROUND

The present disclosure relates to a head-mounted display.

Patent Literature 1 (Japanese Unexamined Patent Application Publication No. 2014-500518) discloses a head-mounted display in which a beam splitter having a curved surface is used. The head-mounted display of Patent Literature 1 includes a nasal ridge piece that separates fields of view of both eyes. The nasal ridge piece is a vertical bar or wall that separates two surfaces.

### SUMMARY

As described above, the head-mounted display is provided with an optical system for guiding display light from a display element to each of left and right eyes. For example, the head-mounted display includes a left-eye display element, a left-eye optical system, a right-eye display element, and a right-eye optical system.

However, the head-mounted display has a problem that a noise component called crosstalk light where display light from a right-eye display element enters the left eye, for example, occurs, which causes degradation of display quality. Particularly, the effect of crosstalk increases in a case where the optical system is enlarged in order to increase the viewing angle in the left-right direction. The crosstalk means that display light from the left or right display element each enters the eye different from the intended eye. This is described with reference to FIG. 11. FIG. 11 is a top view schematically showing the structure of a display element and an optical system.

A beam splitter 122L and a combiner 121L are arranged in front of the left eye EL. Likewise, a beam splitter 122R and a combiner 121R are arranged in front of the right eye ER. Display light PL11 from a left-eye display element 101L arranged above the beam splitter 122L is reflected by the beam splitter 122L and enters the combiner 121L. The display light PL11 that has been reflected by the combiner 121L passes through the beam splitter 122L and enters the left eye EL.

However, part of the display light PL11 that has been reflected by the combiner 121L enters the right eye ER as crosstalk light PCT. Likewise, part of display light from a right-eye display element 101R enters the left eye EL as crosstalk light, though not shown in FIG. 11. When part of the display light from the left or right display element enters the eye on the opposite side as crosstalk light, it acts as a noise component of a display image. This reduces contrast and produces a double image or the like, which may cause degradation of display quality. Patent Literature 1 reduces crosstalk, but has a problem that high display quality cannot be obtained as the vertical bar or wall that separates the two surfaces are emphasized.

A head-mounted display according to an embodiment includes a left-eye optical system configured to guide left-eye display light for forming a left-eye display image to a left eye of a user, a right-eye optical system configured to guide right-eye display light for forming a right-eye display image to a right eye of the user, and a polarizing plate arranged between a space in front of the left eye and a space in front of the right eye, and the space in front of the left eye is a space defined by the left-eye optical system, and the space in front of the right eye is a space defined by the right-eye optical system.

### BRIEF DESCRIPTION OF THE DRAWINGS

FIG. 1 is a view showing a part of the structure of a head-mounted display according to an embodiment.

FIG. 2 is a view showing functional blocks of the head-mounted display according to the embodiment.

FIG. 3 is a view for describing display light and outside light in an optical system of a head-mounted display.

FIG. 4 is a top view schematically showing the structure of an optical system of a head-mounted display according to a first embodiment.

FIG. 5 is a side view schematically showing the structure of the optical system of the head-mounted display according to the first embodiment.

FIG. 6 is a view for describing display light and diplomacy that enter a polarizing plate.

FIG. 7 is a view for describing reflected light PL14 reflected by the polarizing plate.

FIG. 8 is a top view schematically showing the structure of an optical system of a head-mounted display according to a second embodiment.

FIG. 9 is a side view schematically showing the structure of the optical system of the head-mounted display according to the second embodiment.

FIG. 10 is a side view schematically showing the structure of an optical system of a head-mounted display according to a third embodiment.

FIG. 11 is a view for describing crosstalk of display light.

### DETAILED DESCRIPTION

Specific embodiments of the present invention are described hereinafter in detail with reference to the drawings. The present disclosure, however, is not limited to the below-descried embodiments. The following description and the attached drawings are appropriately simplified to clarify the explanation.

### First Embodiment

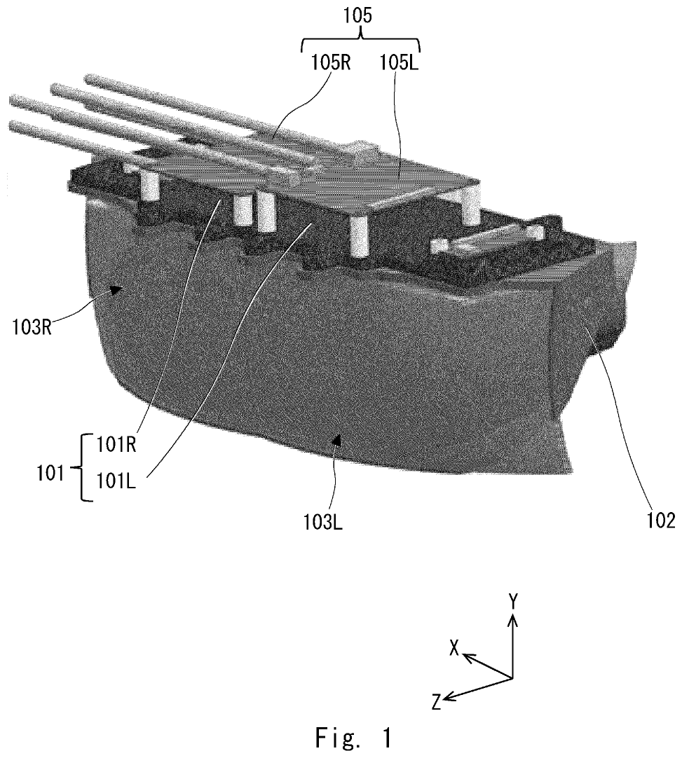

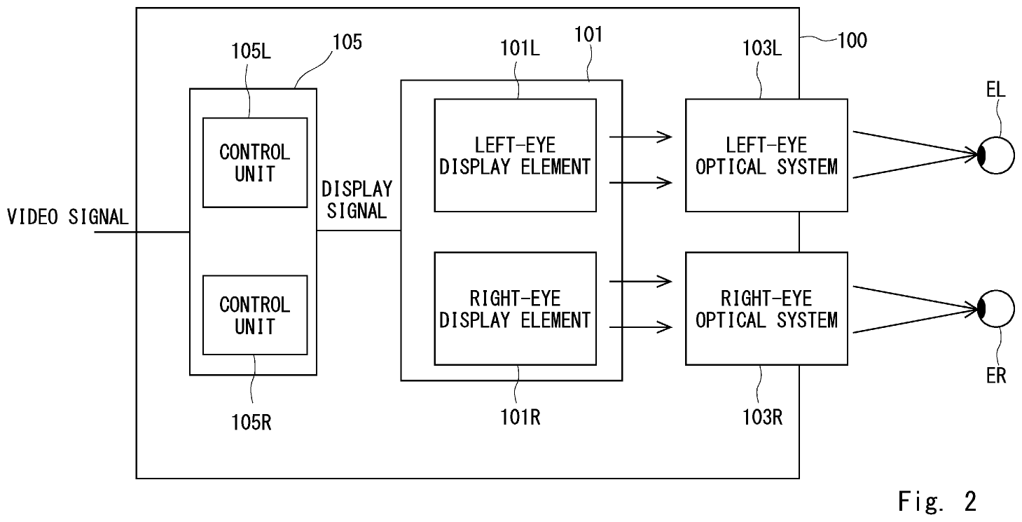

A head-mounted display and a display method of the same according to an embodiment are described hereinafter with reference to the drawings. FIG. 1 is a perspective view schematically showing a part of a structure of a head-mounted display 100. FIG. 2 is a view showing some of functional blocks of the head-mounted display 100. FIGS. 1 and 2 mainly show a structure related to image display of the head-mounted display 100. FIG. 1 shows the internal structure of the head-mounted display 100, and the elements shown in FIG. 1 may be covered with a cover or the like in practice.

The head-mounted display 100 is applicable to various purposes, such as game, entertainment, industrial, medical, and flight simulation purposes. The head-mounted display 100 may be a VR (Virtual Reality) head-mounted display, an AR (Augmented Reality) head-mounted display, or an MR (Mixed Reality) head-mounted display, for example. Note that the head-mounted display 100 is an optical see-through head-mounted display used for AR or MR in this embodiment, but may be a non-transmissive head-mounted display.

To clarify the explanation, an XYZ three-dimensional Cartesian coordinate system is used in the following description. As seen from a user, the front-back direction (depth direction) is Z direction, the left-right direction (horizontal direction) is X direction, and the up-down direction (vertical direction) is Y direction. The front direction is +Z direction, the back direction is −Z direction, the right direction is +X direction, the left direction is −X direction, the up direction is +Y direction, and the down direction is −Y direction.

The user, which is not shown, is wearing the head-mounted display 100. The head-mounted display 100 includes a display element unit 101, a frame 102, a left-eye optical system 103L, a right-eye optical system 103R, and a control unit 105. The control unit 105 includes a control unit 105L and a control unit 105R.

The frame 102 has goggles or glasses shape, and it is worn on the head of the user by a head band, which is not shown, or the like. The display element unit 101, the left-eye optical system 103L, the right-eye optical system 103R, the control unit 105L, and the control unit 105R are mounted on the frame 102. Note that, although the binocular head-mounted display 100 is shown in FIG. 1, the head-mounted display may be a glasses-shaped non-immersive head-mounted display.

The display element unit 101 includes a left-eye display element 101L and a right-eye display element 101R. The left-eye display element 101L generates a display image for a left eye. The right-eye display element 101R generates a display image for a right eye. Each of the left-eye display element 101L and the right-eye display element 101R includes a flat-panel display such as a liquid crystal monitor or an organic EL (Electro-Luminescence) monitor. The left-eye display element 101L and the right-eye display element 101R may be curve-shaped displays. Each of the left-eye display element 110L and the right-eye display element 101R includes a plurality of pixels arranged in an array. The array arrangement is not limited to two-dimensional matrix arrangement, and it may be PenTile arrangement or the like. The left-eye display element 101L is arranged on the left side (−X side) of the right-eye display element 101R.

The control unit 105 is provided above (on the +Y side) the display element unit 101. A video signal, a control signal, and power from the outside are supplied to the control unit 105. For example, a video signal and the like are input to the control unit 105 by wired connection such as HDMI (registered trademark) or wireless connection such as WiFi (registered trademark) or BlueTooth (registered trademark). The head-mounted display 100 may include a video generation unit (not shown) that generates a video signal, and a video signal or the like generated by the video generation unit may be input to the control unit 105.

The control unit 105L and the control unit 105R include hardware resources such as a CPU (Central Processing Unit), a memory and the like, and operates according to a computer program stored in the memory. Further, each of the control unit 105L and the control unit 105R includes a display driving circuit or the like. The control unit 105L generates a display signal of a left-eye image on the basis of a video signal, a control signal and the like and outputs it to the left-eye display element 101L. The left-eye display element 101L thereby outputs display light for displaying the left-eye image. The control unit 105R generates a display signal of a right-eye image on the basis of a video signal, a control signal and the like and outputs it to the right-eye display element 101R. The right-eye display element 101R thereby outputs display light for displaying the right-eye image. In this manner, the control unit 105 outputs display signals to the display element unit 101.

Note that the display element unit 101 does not necessarily have the structure in which the left-eye display element 101L and the right-eye display element 101R are separate display elements, and it may have a single display element. The single display element may generate a display image for a left eye and a display image for a right eye. In this case, the display element unit 101 generates a left-eye image by using a part on one side of the display area of the display and generates a right-eye image by using a part on the other side of the display area of the display.

Some or all of the display element unit 101, the control unit 105 and the like are not necessarily fixed to the frame 102, and they may be mounted detachable from the frame 102. For example, the display element unit 101, the control unit 105 and the like may be implemented by mounting a smartphone or a tablet computer on the frame 102. In this case, an application program (app) that generates display images for the head-mounted display is previously installed into the smartphone or the like.

The left-eye optical system 103L guides the display light that is output from the left-eye display element 101L to the left eye EL of the user as a left-eye image. The right-eye optical system 103R guides the display light that is output from the right-eye display element 101R to the right eye ER of the user as a right-eye image. The left-eye optical system 103L is arranged on the left side (−X side) of the right-eye optical system 103R. The left-eye optical system 103L is arranged in front (+Z direction) of the left eye EL of the user. The right-eye optical system 103R is arranged in front (+Z direction) of the right eye ER of the user. The user is able to see a virtual image of a display image generated by the display element unit 101 in the front (in the +Z direction).

As described above, the head-mounted display 100 according to this embodiment may either be a semitransparent or non-transmissive head-mounted display. Note that the description herein is provided assuming that the head-mounted display 100 is a semitransparent head-mounted display. Thus, the left-eye optical system 103L and the right-eye optical system 103R include a combiner, which is described later. In the semitransparent head-mounted display 100, display light from the display element unit 101 and outside light enter the left eye EL and the right eye ER. Thus, the user is able to see a superimposed image on which a display image is superimposed on a view in the front (in the +Z direction).

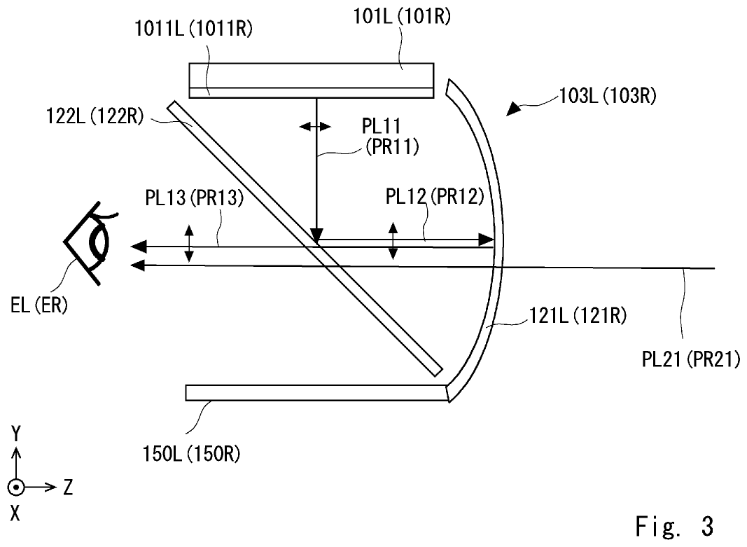

An example of the left-eye optical system 103L and the right-eye optical system 103R (which are collectively referred to simply as an optical system below) is described hereinafter. FIG. 3 is a side view schematically showing the optical system. Note that the left-eye optical system 103L and the right-eye optical system 103R have the same structure, and therefore only the left-eye optical system 103L is described with reference to FIG. 3.

The left-eye optical system 103L includes a combiner 121L, a beam splitter 122L, and a light shielding part 150L. The combiner 121L, the beam splitter 122L, and the light shielding part 150L are fixed to the frame 102 shown in FIG. 1.

The combiner 121L is a concave mirror, and the beam splitter 122L is a plane mirror. The combiner 121L and the beam splitter 122L are beam splitters such as half-mirrors, and reflect part of incident light and transmit part of incident light. When it is assumed that the percentage of reflection and the percentage of transmission in the combiner 121L are equal, the combiner 121L transmits approximately half of the amount of incident light, and reflects the remaining half. Likewise, when it is assumed that the percentage of reflection and the percentage of transmission in the beam splitter 122L are equal, the beam splitter 122L transmits approximately half of the amount of incident light, and reflects the remaining half. The combiner 121L and the beam splitter 122L may increase the percentage of reflection and decrease the percentage of transmission, or may decrease the percentage of reflection and increase the percentage of transmission.

The combiner 121L and the beam splitter 122L are arranged in front (+Z direction) of the user's left eye EL. Further, the combiner 121L is arranged in front (+Z direction) of the beam splitter 122L.

The left-eye display element 101L is arranged above (in the +Y direction) the beam splitter 122L. The left-eye display element 101L outputs the display light PL11 for forming a display image. Thus, the left-eye display element 101L is arranged diagonally above in front of the left eye EL.

The light shielding part 150L is arranged below (in the −Y direction) the beam splitter 122L. Thus, the light shielding part 150L is arranged diagonally below in front of the left eye EL. The light shielding part 150L is provided to shield a field of vision in the diagonally lower front. The light shielding part 150L is formed of a black material or the like that absorbs light. A lower window for viewing the diagonally lower front may be provided instead of the light shielding part 150L.

The display light PL11 from the left-eye display element 101L is described hereinafter. The display surface of the left-eye display element 101L faces vertically downward (in the −Y direction). Thus, the display light PL11 from the left-eye display element 101L is output in the −Y direction. The left-eye display element 101L is a liquid crystal monitor having a liquid crystal display panel, for example. The liquid crystal display panel controls the polarization state of light from a backlight and thereby spatially modulates the light. Therefore, a polarizing member to be a display element polarizer is provided on the output side of the liquid crystal display panel of the left-eye display element 101L. As shown in FIG. 3, for example, a polarizing film 1011L is attached onto the output side of the liquid crystal display panel of the left-eye display element 101L. The polarizing film 1011L transmits linearly polarized light that is parallel to the plane of paper and absorbs linearly polarized light that is orthogonal to the plane of paper. Thus, the display light PL11 generated by the left-eye display element 101L is linearly polarized light. The transmission axis of the polarizing film 101L is in parallel to the Z direction. In FIG. 3, the display light PL11 is linearly polarized light in the Z direction on the output end face of the left-eye display element 101L.

The beam splitter 122L is arranged at an angle below (in the −Y direction) the left-eye display element 101L. The display light PL11 from the left-eye display element 101L enters the beam splitter 122L. The beam splitter 122L reflects part of the display light PL11. The display light PL11 that has been reflected by the beam splitter 122L is referred to as display light PL12. Further, the remaining part of the display light PL11 that has passed through the beam splitter 122L is absorbed by the light shielding part 150L.

The display light PL12 that has been reflected by the beam splitter 122L is reflected forward (in the +Z direction). The display light PL12 that has been reflected by the beam splitter 122L is linearly polarized light in the Y direction. Then, the display light PL12 enters the combiner 121L. The combiner 121L reflects part of the display light PL12 backward (in the −Z direction). The display light PL12 that has been reflected by the combiner 121L is referred to as display light PL13. Further, the combiner 121L is a concave mirror, and reflects the display light PL13 so as to focus the display light PL13 toward the left eye EL. The display light PL13 that has been reflected by the combiner 121L enters the beam splitter 122L. The beam splitter 122L transmits part of the display light PL13.

The display light PL13 that has passed through the beam splitter 122L enters the left eye EL. In this manner, the left-eye optical system 103L guides the display light PL11 from the left-eye display element 101L to the user's left eye EL. The optical system can display the virtual image in front (in the +Z direction) of the user. Further, since a concave mirror is used as the combiner 121L, the display image is displayed in a larger scale.

The outside light PL21 from the front (+Z direction) of the user is described hereinafter. Part of the outside light PL21 passes through the combiner 121L. The outside light PL21 that has passed through the combiner 121L enters the beam splitter 122L. The beam splitter 122L transmits part of the outside light PL21. The outside light PL21 that has passed through the beam splitter 122L enters the left eye EL.

Since the head-mounted display 100 is semitransparent, the combiner 121L combines the outside light PL21 from the front (+Z direction) and the display light PL11 from the left-eye display element 101L. By arranging the combiner 121L in front (in the +Z direction) of the user, the head-mounted display 100 functions as an optical see-through display. A display image is superimposed on a view in front (in the +Z direction) of the user. The user is thereby able to see a view on which the display image is superimposed.

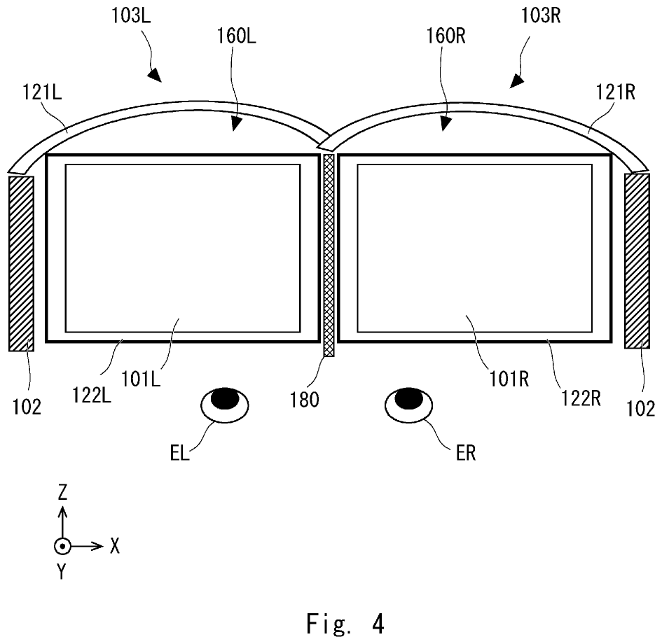

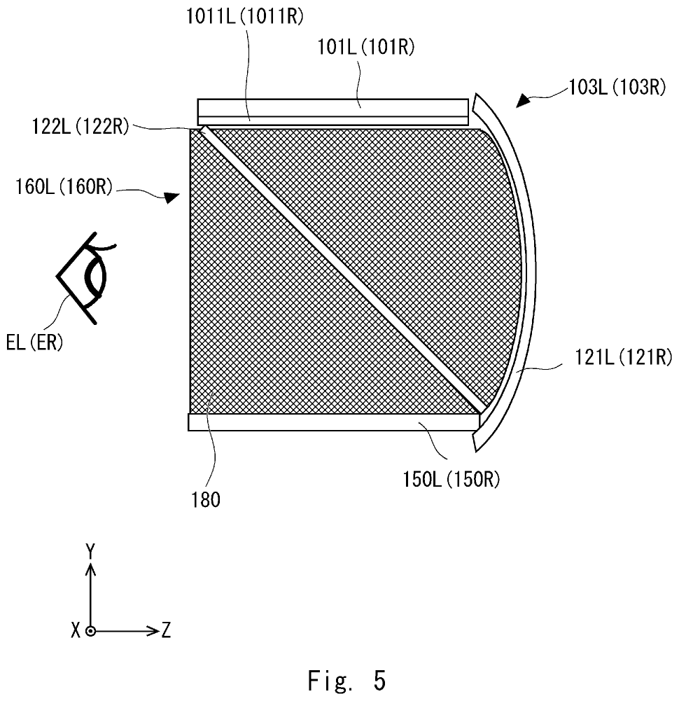

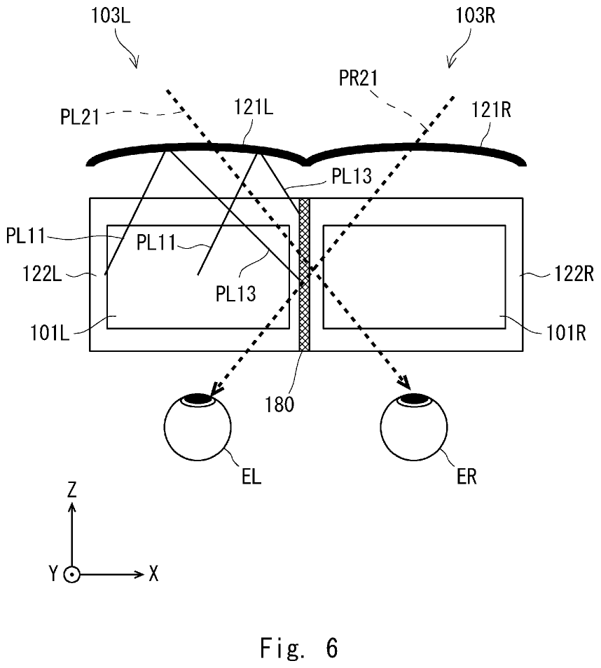

The structure for reducing crosstalk is described hereinafter with reference to FIGS. 4 to 6. FIG. 4 is a top view schematically showing the optical system, and FIG. 5 is a side sectional view. FIG. 6 is a view for describing the outside light PL21 and the display light PL13 that enter a polarizing plate 180, and schematically shows the structure of the optical system as seen from above. As shown in FIGS. 4 to 6, the polarizing plate 180 is provided between the left-eye optical system 103L and the right-eye optical system 103R.

The polarizing plate 180 is arranged between a space in front (in the +Z direction) of the left eye EL (which is referred to as the left front space 160L below) and a space in front (in the +Z direction) of the right eye ER (which is referred to as the right front space 160R below). The left front space 160L and the right front space 160R are divided by the polarizing plate 180. The polarizing plate 180 defines the boundary between the left front space 160L and the right front space 160R in the X direction. The polarizing plate 180 serves as a divider part that divides the left front space 160L and the right front space 160R.

Note that the left front space 160L is a space defined by the combiner 121L, the left-eye display element 101L, the light shielding part 150L, the polarizing plate 180, the frame 102 (see FIG. 1 together), and the user's face. Thus, the front side (in the +Z direction) of the left front space 160L faces the combiner 121L, and the rear side (in the −Z direction) faces the user's face. The upper side (in the +Y direction) of the left front space 160L faces the left-eye display element 101L, and the lower side (in the −Y direction) faces the light shielding part 150L. The right side (in the +X direction) of the left front space 160L faces the polarizing plate 180, and the left side (in the −X direction) faces the frame 102.

Likewise, the right front space 160R is a space defined by the combiner 121R, the right-eye display element 101R, the light shielding part 150R, the polarizing plate 180, the frame 102 (see FIG. 1 together), and the user's face. Thus, the front side (in the +Z direction) of the right front space 160R faces the combiner 121R, and the rear side (in the −Z direction) faces the user's face. The upper side (in the +Y direction) of the right front space 160R faces the right-eye display element 101R, and the lower side (in the −Y direction) faces the light shielding part 150R. The right side (in the +X direction) of the right front space 160R faces the frame 102, and the left side (in the −X direction) faces the polarizing plate 180.

The polarizing plate 180 is arranged in front of and behind the beam splitters 122L and 122R. The polarizing plate 180 is a polarizing plate. To be specific, the polarizing plate 180 is arranged along the Y-Z plane. In other words, the X direction is the thickness direction of the polarizing plate 180. The polarizing plate 180 is, for example, a polarizing film of an iodine compound, a wire grid polarizer, or a polarizer of a dielectric film.

An absorptive polarizing plate can be used as the polarizing plate 180. The absorptive polarizing plate is a polarizing film of an iodine compound, for example. The polarizing plate 180 transmits linearly polarized light that is parallel to its transmission axis, and absorbs linearly polarized light that is orthogonal to the transmission axis. Herein, the transmission axis of the polarizing plate 180 extends in the Z direction, and the absorption axis extends in the Y direction. In other words, transmission of the polarizing plate 180 is orthogonal to the polarization direction of the display light PL12 and PL13. The polarizing plate 180 and the polarizing film 1011L are arranged to form crossed Nicols. The crossed Nicols refers to such an arrangement that the transmission axis of one polarizing plate and the transmission axis of the other polarizing plate cross at an angle of substantially 90°. Note that the crossed Nicols herein indicates that the polarizing plate 180 and the polarizing film 1011L are arranged in a direction that their transmission axes are orthogonal to each other upon consideration of reflection by the beam splitter 122L and the combiner 121L. In other words, the crossed Nicols indicates such an arrangement that the transmission axis of the polarizing plate 180 is orthogonal to the polarization direction of light that has passed through the polarizing film 1011L and has been reflected by the beam splitter 122L and the polarization direction of light that has passed through the polarizing film 1011L and has been reflected by the combiner 121L.

Since the display light PL13 that has been reflected by the combiner 121L is linearly polarized light in the Y direction, the display light PL13 is absorbed by the polarizing plate 180 as shown in FIG. 6. This prevents the display light PL13 that has been generated by the left-eye display element 101L from entering the right-eye optical system 103R. Note that PL12 that has been generated by the left-eye display element 101L is also linearly polarized light in the Y direction. The polarizing plate 180 blocks light by absorbing the display light PL12 that has been generated by the left-eye display element 101L. This also prevents PL12 that has been generated by the left-eye display element 101L from entering the right-eye optical system 103R.

Note that although illustration is omitted in FIG. 6, the polarizing plate 180 also blocks the display light PR12 and PR13 from the right-eye display element 101R. The transmission axis of the polarizing film 1011R is in parallel to the transmission axis of the polarizing film 1011L. and the display light PR11 of the right-eye display element 101R is also linearly polarized light in the Z direction. The display light PR11 from the right-eye display element 101R is linearly polarized light that is parallel to the polarization direction of the display light PL11 from the left-eye display element 101L. The display light PR12 that has been reflected by the beam splitter 122R is linearly polarized light in the Y direction. The display light PR13 that has been reflected by the combiner 121R is linearly polarized light in the Y direction. The polarizing plate 180 blocks light by absorbing the display light PR12 and PR13 that have been generated by the right-eye display element 101R. This prevents the display light PR12 and PR13 that have been generated by the right-eye display element 101R from entering the left-eye optical system 103L.

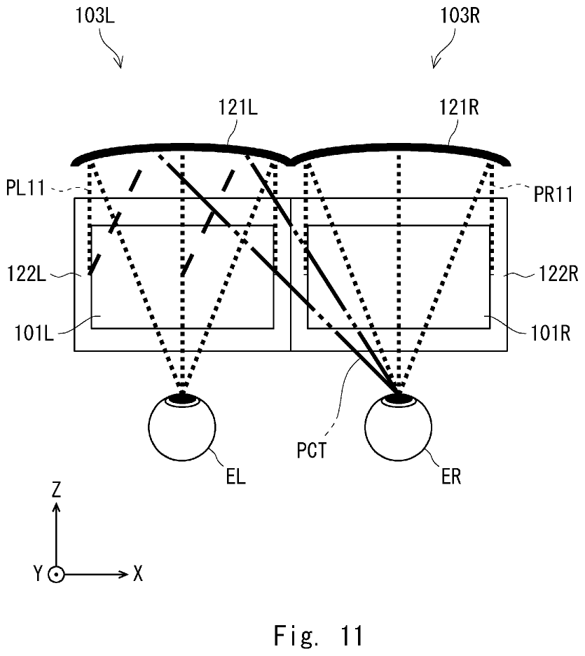

The polarizing plate 180 blocks the display light PL12 and PL13 from the left-eye optical system 103L from entering the right eye ER. The polarizing plate 180 also blocks the display light PR12 and PR13 from the right-eye optical system 103R from entering the left eye EL. The polarizing plate 180 blocks the crosstalk light PCT shown in FIG. 11. This reduces crosstalk, and improves display quality.

On the other hand, the outside light PL21 is natural light, and is thus non-polarized light. Thus, as shown in FIG. 6, part of the outside light PL21 passes through the polarizing plate 180. In other words, of the outside light PL21 that has passed through the polarizing plate 180, a linearly polarized light component in the Z direction passes through the polarizing plate 180. The user is able to see the outside through the polarizing plate 180. This increases a user's viewing angle with respect to the outside world. In other words, the outside light PL21 that travels from the front side of the combiner 121L to the diagonally backward right enters the right eye ER through the polarizing plate 180. The right eye ER is able to see a view at the diagonally forward left through the polarizing plate 180. Further, the outside light PR21 that travels from the front side of the combiner 121R to the diagonally backward left enters the left eye EL through the polarizing plate 180. In other words, the left eye EL is able to see a view at the diagonally forward right through the polarizing plate 180. This increases a viewing filed of a real field of vision in the left-right direction.

In this manner, the polarizing plate 180 whose thickness direction is the left-right direction (the X direction) is arranged between the left-eye optical system 103L and the right-eye optical system 103R. The shape of the polarizing plate 180 on the Y-Z plane is determined in accordance with the shape of the left front space 160L and the right front space 160R. For example, the end sides of the polarizing plate 180 are shaped along the display element unit 101, the light shielding parts 150L, 150R, and the combiners 121L and 121R. As shown in FIG. 5, an end side of the polarizing plate 180 in the front (in the +Z direction) is formed along the curves of the combiners 121L and 121R. In other words, the end side of the polarizing plate 180 in the front (in the +Z direction) is formed as an arc on the Y-Z plane. This allows the left front space 160L and the right front space 160R to be divided properly, which reduces crosstalk effectively.

Note that the shape of the polarizing plate 180 is not limited to the above-described shape. The polarizing plate 180 does not need to fully divide the left front space 160L and the right front space 160R. In other words, the left front space 160L and the right front space 160R may partly be connected to each other.

The above-described polarization directions and the transmission axis direction of the polarizing plate 180 are examples of an embodiment, and are not limited to the above-described directions. Further, although the transmission axis of the polarizing plate 180 is orthogonal to the polarization direction of the display light PL12 and PL13, the transmission axis of the polarizing plate 180 may not be orthogonal to the polarization direction of the display light PL12 and PL13. For example, the transmission axis of the polarizing plate 180 may extend in a direction rotated 45° from the Z direction about the X axis. In other words, in whichever direction the transmission axis of the polarizing plate 180 extends, a polarization component of the display light PL13 that is orthogonal to the transmission axis of the polarizing plate 180 is blocked. Since part of crosstalk light is blocked, display quality is improved.

The directions of transmission axes of the polarizing plate 180 and the polarizing films 1011L, 1011R are not limited to the aforementioned directions. Further, although it is described that the left-eye display element 101L and the right-eye display element 101R generate the display light PL11 and PR11 which are linearly polarized light, the display light PL11 and PR II may be non-polarized light. For example, the left-eye display element 101L and the right-eye display element 101R which are OLED (organic light-emitting diode) monitors may output the display light PL11 and PR11 which are non-polarized light. Even in this case, crosstalk light is reduced to half. Degradation of display quality is prevented. Obviously, in a case of using monitors that output the display light PL11 and PR11 which are non-polarized light, an additional polarizing plate may be provided on the output side of the monitors in such a way that the display light PL11 and PR11 become linearly polarized light. This allows crosstalk light to be blocked, and allows higher display quality to be obtained.

### Modified Example

In a modified example, an antireflection film or an antireflection structure is formed on the polarizing plate 180. By providing the antireflection film or the antireflection structure on the surface of the polarizing plate 180, light to be reflected by the polarizing plate 180 is reduced. Note that the antireflection film or the antireflection structure may be formed on both surfaces of the polarizing plate 180, or may be formed only on one surface. In other words, it is preferable to form an antireflection structure or the like on at least one of the right side (+X side) surface or left side (−X side) surface of the polarizing plate 180.

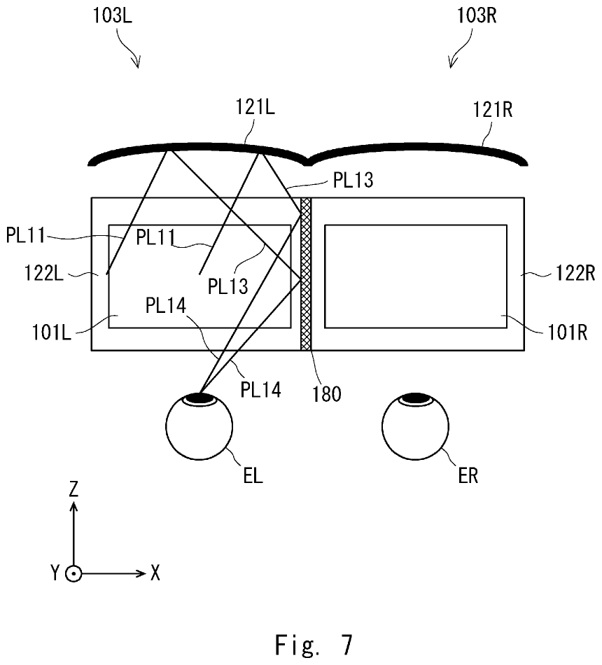

In a case where an antireflection film or an antireflection structure is not provided, approximately several percent of the display light PL13 that has entered the polarizing plate 180 will be reflected. In FIG. 7, of the display light PL13, reflected light that has been reflected by the polarizing plate 180 is indicated as reflected light PL14. Part of the reflected light PL14 that has been reflected by the surface of the polarizing plate 180 enters the user's eyes as shown in FIG. 7. When the reflected light PL14 that has been reflected by the polarizing plate 180 enters the eyes, it becomes a noise component, which reduces contrast or the like. In the case where the polarizing plate 180 does not have any antireflection film or antireflection structure, display quality may degrade.

Thus, it is preferable to form an antireflection film or an antireflection structure on the surface of the polarizing plate 180. A dielectric multilayer film or a dielectric film can be used as the antireflection film. A nanostructure can be used as the antireflection structure, or a moth-eye structure having a cycle shorter than that of visible light, for example, may be adopted. In this manner, by providing the polarizing plate 180 with an antireflection function, higher display quality is obtained.

### Second Embodiment

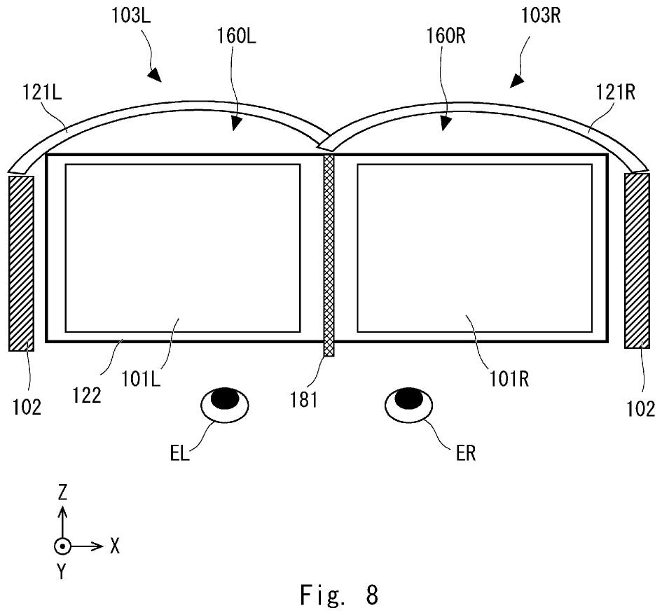

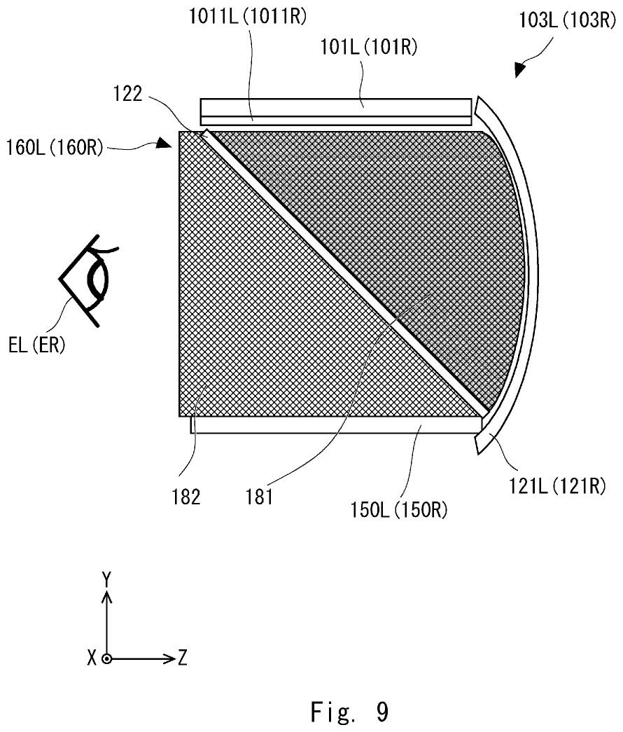

The head-mounted display 100 according to this embodiment is described with reference to FIGS. 8 and 9. FIG. 8 is a top view schematically showing an optical system of the head-mounted display 100 according to this embodiment, and FIG. 9 is a side sectional view. In this embodiment, left and right beam splitters 122 are formed integrally. In other words, the beam splitter 122L and the beam splitter 122R are implemented by a single beam splitter 122. The beam splitter 122 is arranged across the left front space 160L and the right front space 160R. Note that the basic structure except the beam splitter 122 is the same as that of the first embodiment, and description thereof is thus omitted.

The left-eye optical system 103L and the right-eye optical system 103R share the beam splitter 122. This prevents misalignment of virtual images between the left-eye optical system 103L and the right-eye optical system 103R. In other words, in the structure in which the beam splitter 122L and the beam splitter 122R are provided separately as in the first embodiment, left and right virtual images are displayed in a manner misaligned from each other in the up-down direction (the Y direction) when the beam splitter 122L and the beam splitter 122R are arranged at angles different from each other. Since this embodiment prevents virtual images from being misaligned in the up-down direction (the Y direction), high display quality is obtained.

The left-eye optical system 103L and the right-eye optical system 103R share the single beam splitter 122. Thus, the polarizing plate 180 cannot be arranged between the left and right beam splitters 122L and 122R as in the first embodiment. In this embodiment, two polarizing plates 181 and 182 are used. The polarizing plate 181 is arranged in front (in the +Z direction) of the beam splitter 122. The polarizing plate 182 is arranged behind (in the −Z direction) the beam splitter 122. The polarizing plates 181 and 182 are arranged between the left front space 160L and the right front space 160R.

The transmission axes of the polarizing plates 181 and 182 are in parallel to the Z direction. The polarizing plate 181 forms crossed Nicols with the polarizing films 1011L and 1011R upon consideration of reflection by the beam splitter 122, the combiner 121L, and the combiner 121R. Likewise, the polarizing plate 182 forms crossed Nicols with the polarizing films 1011L and 1011R upon consideration of reflection by the beam splitter 122, the combiner 121L, and the combiner 121R. Thus, when the display light PL13 and PR13 that have been reflected by the combiners 121L and 121R enter the polarizing plates 181 and 182, they are absorbed by the polarizing plates 181 and 182. Further, when the display light PL12 and PR12 that have been reflected by the beam splitter 122 enter the polarizing plate 181, they are absorbed by the polarizing plate 181. This reduces crosstalk light similarly to the first embodiment, which allows display quality to be improved.

### Third Embodiment

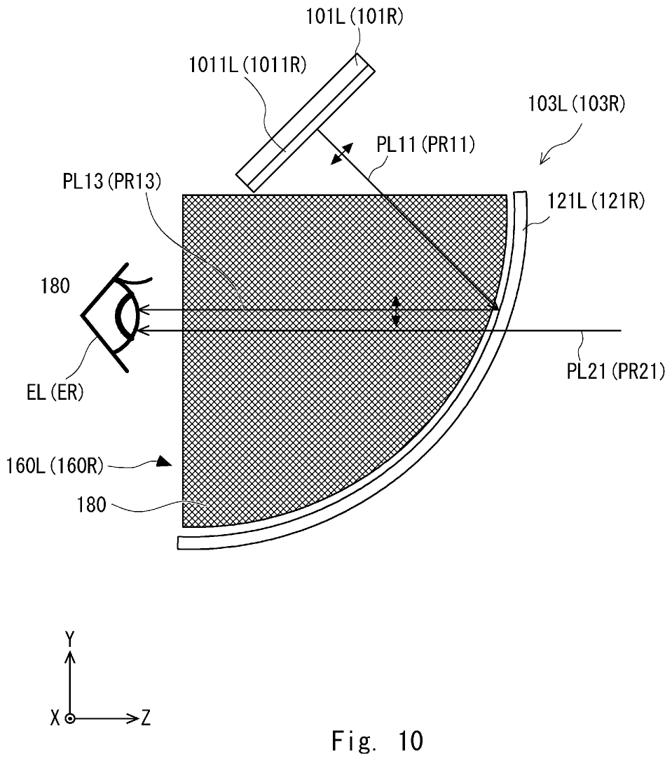

The head-mounted display 100 according to a third embodiment is described with reference to FIG. 10. FIG. 10 is a side view schematically showing the structure of the head-mounted display 100. In this embodiment, the head-mounted display 100 is of the single mirror type unlike the first and second embodiments. In other words, neither the beam splitter 122L nor the beam splitter 122 is provided between the left eye EL and the combiner 121L. Note that the basic structure except the beam splitter 122 is the same as that of the first embodiment, and description thereof is thus omitted.

The angle at which the left-eye display element 101L is located is different from that in the first and second embodiments. The left-eye display element 101L is arranged diagonally. In other words, the display surface of the left-eye display element 101L faces downward (in the −Y direction) and forward (in the +Z direction). The display light PL11 from the left-eye display element 101L is output in the −Y direction and the +Z direction. The display light PL11 is linearly polarized light in the direction that is orthogonal to the X direction on the display surface. The combiner 121L is arranged below (in the −Y direction) the left-eye display element 101L. The combiner 121L transmits half of light, and reflects the remaining half.

The combiner 121L reflects the display light PL11 from the left-eye display element 101L toward the left eye EL. The display light PL11 that has been reflected by the combiner 121L is referred to as display light PL13. The combiner 121L is a concave half mirror, and reflects the display light PL13 so as to focus the display light PL13 toward the left eye EL. The display light PL13 is linearly polarized light that is in parallel to the Y direction. The left-eye optical system 103L guides the display light from the left-eye display element 101L to the left eye EL. The optical system allows a virtual image to be displayed in front (in the +Z direction) of the user.

Further, the outside light PL21 passes through the combiner 121L and enters the left eye EL. The transmittance of the combiner 121L is 50%. Thus, the outside light PL21 is attenuated to 50% by passing through the combiner 121L. Then, the outside light PL21 that has been attenuated to 50% enters the left eye EL. This allows a display image to be superimposed on a view in the front (in the +Z direction). Further, since the combiner 121L extends to a place immediately below the left-eye display element 101L in this embodiment, the light shielding part 150L is not provided.

The polarizing plate 180 is arranged between the left front space 160L and the right front space 160R. The polarizing plate 180 is arranged between the left-eye optical system 103L and the right-eye optical system 103R. The transmission axis of the polarizing plate 180 extends in a direction parallel to the Y direction. The polarizing plate 180 forms crossed Nicols with the polarizing films 1011L and 1011R upon consideration of reflection by the combiners 121L and 121R. The crossed Nicols in this embodiment refers to such an arrangement that the transmission axis of the polarizing plate 180 is orthogonal to the polarization direction of light that has passed through the polarizing films 1011L and 1011R and has been reflected by the beam splitter 122L. Thus, when the display light PL13 and PR13 that have been reflected by the combiners 121L and 121R enter the polarizing plate 180, they are absorbed.

This allows the crosstalk light PCT to be blocked similarly to the first and second embodiments. Display quality is thereby improved. Further, since the beam splitter 122 is not provided in FIG. 10, crosstalk light is reduced with the single polarizing plate 180 similarly to the first embodiment.

Note that although the head-mounted display 100 is described as an optical see-through head-mounted display, the head-mounted display 100 may be a non-transmissive head-mounted display. In the case of a non-transmissive head-mounted display, reflective mirrors are provided instead of the combiners 121L and 121R. In other words, a reflective member arranged in front of the beam splitter 122L may be a beam splitter such as a half mirror, or may be a reflective mirror. The reflective member reflects display light toward the user.

Although the embodiments of the invention made by the present inventors are described in the foregoing, the present invention is not restricted to the above-described embodiments, and various changes and modifications may be made without departing from the scope of the invention. Two or more of the above-described embodiments may be combined as appropriate.

The present disclosure is applicable to a head-mounted display.

What is claimed is:

1. A head-mounted display comprising:
a left-eye optical system configured to guide left-eye display light for forming a left-eye display image to a left eye of a user;
a right-eye optical system configured to guide right-eye display light for forming a right-eye display image to a right eye of the user;
a display element unit configured to generate the right-eye display light and the left-eye display light; and
a polarizing plate arranged between a space in front of the left eye and a space in front of the right eye, wherein
the space in front of the left eye is a space defined by the left-eye optical system, and the space in front of the right eye is a space defined by the right-eye optical system,
a display element polarizer is provided on an output side of the display element unit, and
the display element polarizer and the polarizing plate form crossed Nicols.

2. The head-mounted display according to claim 1, wherein the crossed Nicols refers to arranging the display element polarizer and the polarizing plate in a direction in which a transmission axis of the polarizing plate and a transmission axis of the display element polarizer are orthogonal to each other upon consideration of reflection by the left-eye optical system and the right-eye optical system.

3. The head-mounted display according to claim 1, wherein the left-eye display light that enters the left-eye optical system from the display element unit and the right-eye display light that enters the right-eye optical system from the display element unit are linearly polarized light parallel to each other.

4. The head-mounted display according to claim 1, wherein an antireflection film or an antireflection structure is formed on the polarizing plate.
